(19) United States
(12) Patent Application Publication
(10) Pub. No.: US 2008/0246903 A1
(43) Pub. Date: Oct. 9, 2008

(54) Liquid crystal display

(75) Inventors: Yun-jae Park, Yongin-si (KR); Ki-Chan Lee, Cheonan-si (KR)

Correspondence Address: MACPHERSON KWOK CHEN & HEID LLP, 2033 GATEWAY PLACE, SUITE 400, SAN JOSE, CA, 95110, US

(73) Assignee: Samsung Electronics Co., Ltd.

(21) Appl. No.: 12/079,742

(22) Filed: Mar. 27, 2008

(30) Foreign Application Priority Data
Apr. 4, 2007 (KR) 10-2007-0033261

(51) Int. Cl. G02F 1/1333; G09G 3/36

(52) U.S. Cl. 349/72; 345/101

(57) ABSTRACT

A liquid crystal display (LCD) which includes a liquid crystal panel and a temperature-measurement apparatus. The temperature-measurement apparatus includes a temperature sensor which includes a variable-resistance element having a resistance that varies according to the temperature of the liquid crystal panel and a fixed-resistance element connected in series to the variable-resistance element, divides a first input voltage, and outputs a first temperature-dependent voltage that varies according to a temperature of the liquid crystal panel. A voltage divider which divides a second input voltage and outputs a reference voltage is provided. A differential amplifier receives at a first input the first temperature-dependent voltage and receives at a second input the reference voltage and amplifies a difference between the first temperature-dependent voltage and the reference voltage, and provides at an output a second temperature-dependent voltage.

### CROSS-REFERENCE TO RELATED APPLICATION

This application claims priority from Korean Patent Application No. 10-2007-0033261 filed on Apr. 4, 2007 in the Korean Intellectual Property Office, the disclosure of which is incorporated herein by reference in its entirety.

### BACKGROUND OF THE INVENTION

1. Field of the Invention

The present invention relates to a liquid crystal display (LCD).

2. Description of the Related Art

Examples of display devices include: cathode ray tubes (CRTs), organic light emitting diode displays (OLEDs), and plasma display panels (PDPs) which can emit light without requiring a light source; and liquid crystal displays (LCDs) which can emit light with the aid of a light source. The operating characteristics of display devices vary according to temperature.

For example, LCDs display an image by applying an electric field to a liquid crystal layer and adjusting the intensity of the electric field such that the transmissivity of the liquid crystal layer can be varied. The optical characteristics of liquid crystal materials, e.g., the refractive index, dielectric constant, elasticity coefficient and viscosity of liquid crystal materials, vary as a function of temperature. Therefore, in order to properly drive an LCD under varying temperature conditions, a number of operating conditions, e.g., the voltage of a gate signal or signal-processing conditions for improving the response speed of a liquid crystal layer, must be appropriately adjusted according to temperature.

Since the operating characteristics of display devices vary as a function of temperature, there is a need to detect temperature variations in display devices in order to optimize the operation of display devices.

### SUMMARY OF THE INVENTION

Aspects of the present invention provide a liquid crystal display (LCD) which can sense temperature variations.

However, the aspects of the present invention are not restricted to the one set forth herein. The above and other aspects of the present invention will become apparent to one of daily skill in the art to which the present invention pertains by referencing the detailed description of the present invention given below.

According to an aspect of the present invention, there is provided an LCD including a liquid crystal panel and a temperature-measurement apparatus. The temperature-measurement apparatus includes a temperature sensor which has a variable-resistance element having a resistance that varies according to the temperature of the liquid crystal panel and a fixed-resistance element connected in series to the variable-resistance element, divides a first input voltage, and outputs a first temperature-dependent variable voltage that varies according to a temperature of the liquid crystal panel; a voltage divider that divides a second input voltage and outputs a reference voltage; and a differential amplifier that amplifies a difference between the first temperature-dependent variable voltage and the reference voltage and outputs a second temperature-dependent variable voltage.

According to another aspect of the present invention, there is provided an LCD including: a liquid crystal panel; one or more temperature-measurement apparatuses that output a first temperature-dependent variable voltage that varies according to the temperature of the liquid crystal panel; and a calibrator that calibrates the first temperature-dependent variable voltage and outputs temperature information. The calibrator calibrates the first temperature-dependent variable voltage to be as high as a target voltage on a target temperature-voltage graph, and outputs temperature information regarding the target voltage on the target temperature-voltage graph, the target temperature-voltage graph indicating a target voltage corresponding to the temperature of the liquid crystal panel.

### BRIEF DESCRIPTION OF THE DRAWINGS

The above and other aspects and features of the present invention will become apparent in light of the following detailed description of exemplary embodiments thereof with reference to the attached drawings, in which:

FIG. 1 is a circuit diagram of a liquid crystal display (LCD) according to an embodiment of the present invention;

FIG. 2 is a circuit diagram of the temperature-measurement apparatus illustrated in FIG. 1;

FIG. 3 is a graph for explaining the operation of a variable-resistance element illustrated in FIG. 2;

FIG. 4 is a graph for explaining the operation of the differential amplifier illustrated in FIG. 2;

FIG. 5 is a layout illustrating a display area and the variable-resistance element illustrated in FIG. 1;

FIG. 6 is a cross-sectional view taken along line VI-VI′ of FIG. 5;

FIG. 7 is a cross-sectional view taken along line VII-VII′ of FIG. 5;

FIG. 8 is a block diagram of an LCD according to another embodiment of the present invention;

FIG. 9 is a graph for explaining the operation of a calibrator illustrated in FIG. 8;

FIG. 10 is a block diagram of an LCD according to another embodiment of the present invention; and

FIG. 11 is a graph for explaining the operation of the calibrator illustrated in FIG. 10.

### DETAILED DESCRIPTION OF THE EXEMPLARY EMBODIMENTS

The invention is described more fully hereinafter with reference to the accompanying drawings, in which exemplary embodiments of the present invention are illustrated. The invention may, however, be embodied in different forms and should not be construed as limited to the embodiments set forth herein. Rather, these embodiments are provided so that this disclosure will be thorough and complete, and will fully convey the scope of the present invention to those skilled in the art.

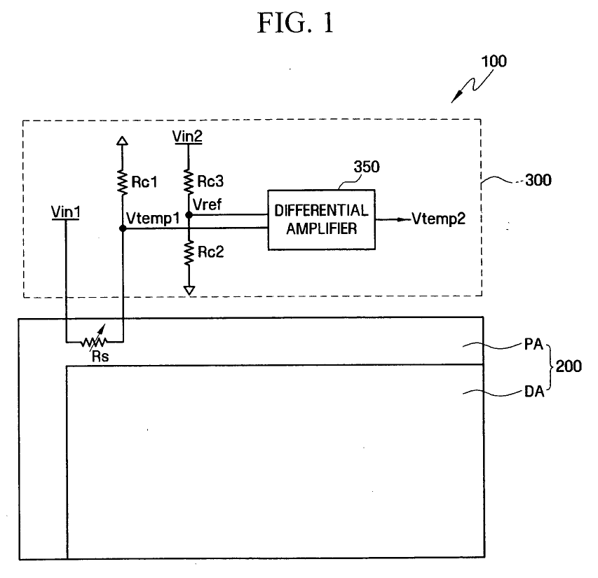

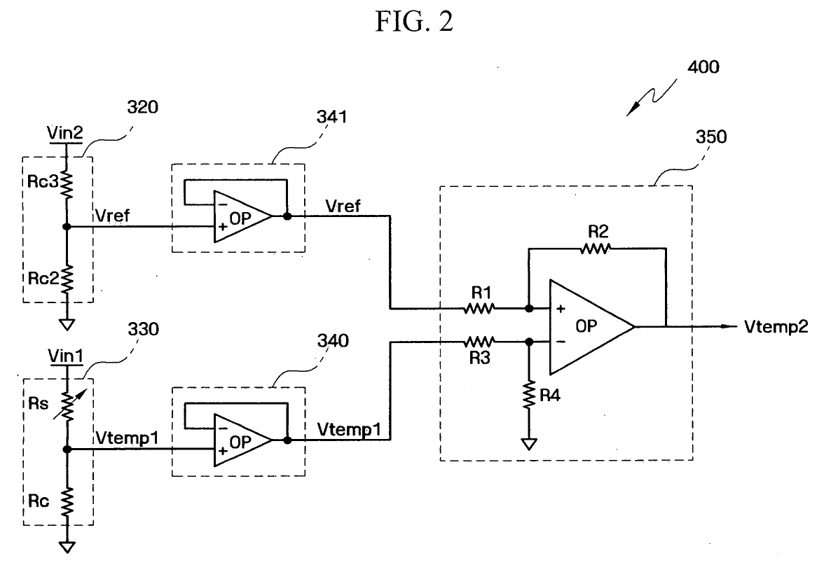

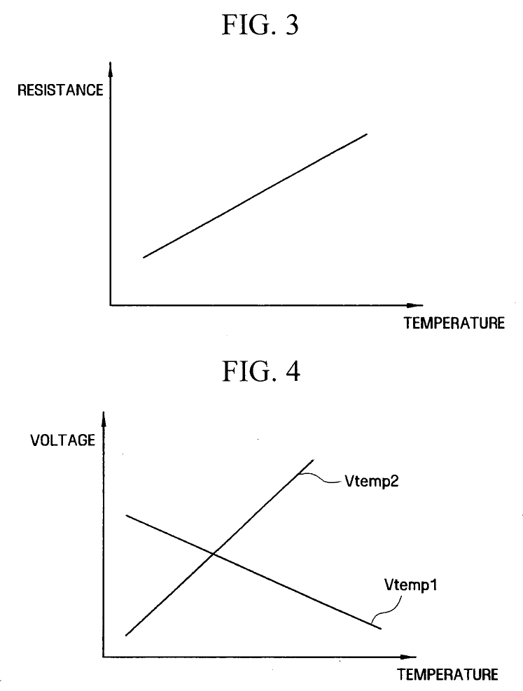

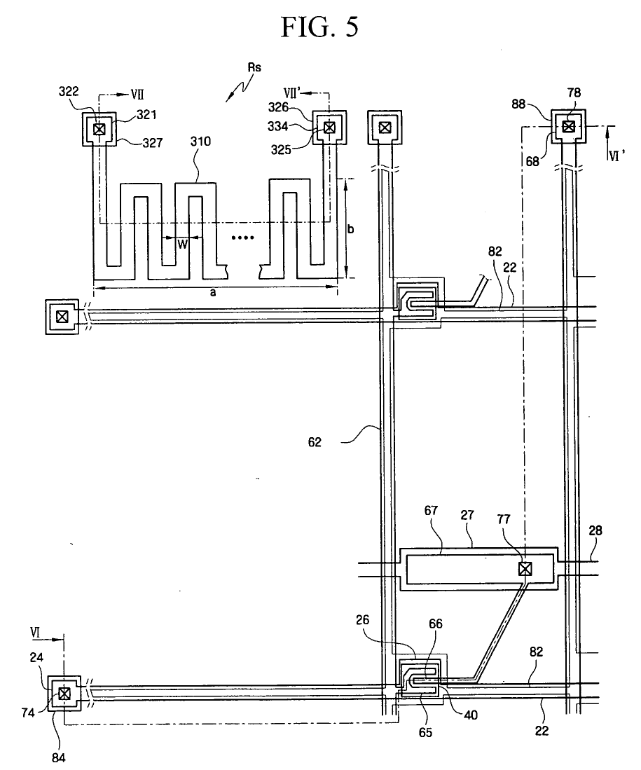

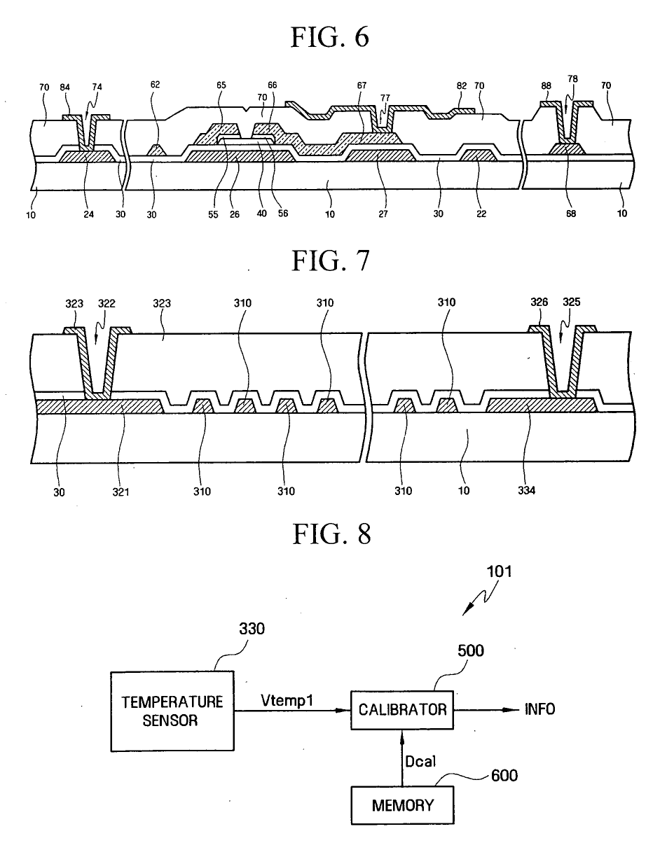

A liquid crystal display (LCD) according to an embodiment of the present invention is hereinafter described in detail with reference to FIGS. 1 through 7. FIG. 1 is a circuit diagram of a liquid crystal display (LCD) 100 according to an embodiment of the present invention, FIG. 2 is a circuit diagram of a temperature-measurement apparatus 400 illustrated in FIG. 1; FIG. 3 is a graph for explaining an operation of the variable-resistance element Rs illustrated in FIG. 2; FIG. 4 is a graph for explaining an operation of the differential amplifier 350 illustrated in FIG. 2; FIG. 5 is a layout illustrating a display region DA and the variable-resistance element Rs illustrated in FIG. 1, FIG. 6 is a cross-sectional view taken along line VI-VI′ of FIG. 5, and FIG. 7 is a cross-sectional view taken along line VII-VII′ of FIG. 5.

Referring to FIGS. 1 and 2, the LCD 100 includes a liquid crystal panel 200 and the temperature-measurement apparatus 400.

The liquid crystal panel 200 includes the display area DA and a non-display area PA.

The display area DA includes a plurality of gate lines (not shown), a plurality of data lines (not shown), and a plurality of pixels (not shown) which are respectively disposed at intersections between the data lines and the gate lines. The display area DA displays an image. The structure of the display area DA and a method of forming the display area DA is described later in detail with reference to FIGS. 5 through 7.

The temperature-measurement apparatus 400 includes a temperature sensor 330, a voltage divider 320, and the differential amplifier 350. The temperature-measurement apparatus 400 measures the temperature of the liquid crystal panel 200.

The temperature sensor 330 outputs a first temperature-dependent voltage Vtemp1 which varies as a function of the temperature of the liquid crystal panel 200. The temperature sensor 330 includes the variable-resistance element Rs which has resistance that varies as a function of the temperature of the liquid crystal panel 200 and a first fixed-resistance element Rc1 which is connected in series to the variable-resistance element Rs. Specifically, referring to FIG. 2, the variable-resistance element Rs is included in the liquid crystal panel 200, and, particularly, in the non-display area PA of the liquid crystal panel 200. That is, the resistance of the variable-resistance element Rs varies as a function of the temperature of the liquid crystal panel 200.

The temperature sensor 330 divides a first input voltage Vin1 and outputs the first temperature-dependent variable voltage Vtemp1. Referring to FIG. 3, the resistance of the variable-resistance element Rs may increase as temperature increases, and may decrease as temperature decreases. Referring to FIG. 4, the first temperature-dependent variable voltage Vtemp1 may decrease as temperature increases, and may increase as temperature decreases. If the variable-resistance element Rs is connected to a ground, and the first input voltage Vin1 is applied to the first fixed-resistance element Rc1, as illustrated in FIG. 2, the first temperature-dependent variable voltage Vtemp1 may increase as the temperature increases, and may decrease as the temperature decreases. Assume that the structure of the temperature sensor 330 is as illustrated in FIG. 2.

The voltage divider 320 generates a reference voltage Vref by dividing a second input voltage Vin2. The reference voltage Vref may be greater than or equal to the first temperature-dependent variable voltage Vtemp1. When the second input voltage Vin2 is the same as the first input voltage Vin1, the first fixed-resistance element Rc1 and a second fixed-resistance element Rc2 have the same resistance, e.g., 1.5 kΩ, the resistance of the variable-resistance element Rs varies within the range of 1.35 kΩ-1.75 kΩ, the resistance of a third fixed-resistance element Rc3 may be 1 kΩ, which is the same as or lower than the minimum resistance of the variable-resistance element Rs.

The differential amplifier 350 amplifies the difference between the first temperature-dependent variable voltage Vtemp1 and the reference voltage Vref and outputs a second temperature-dependent variable voltage Vtemp2 as the result of the amplification. The second temperature-dependent variable voltage Vtemp2 may be represented by Equation (1):

Vtemp2=(Vref−Vtemp1)×R2/R1.

The differential amplifier 350 increases the range of variation of the first temperature-dependent variable voltage Vtemp1 according to temperature, and outputs the second temperature-dependent variable voltage Vtemp2, as illustrated in FIG. 4. The differential amplifier 350 removes noise (from the first temperature-dependent variable voltage Vtemp1) and outputs an amplified second-temperature variable voltage Vtemp2. That is, the differential amplifier 350 enhances the sensitivity of the temperature sensor 330. For example, if the resistance of a first resistor R1 is 1.8 kΩ and the resistance of a second resistor R2 is 18 kΩ, the sensitivity of the temperature sensor 330 may increase ten times. Thus, the temperature-measurement apparatus 400 can precisely measure the temperature of the liquid crystal panel 200. The sensitivity of the temperature sensor 330 may be adjusted by varying the resistances of the first and second resistors R1 and R2.

The structure of the variable-resistance element Rs and a method of forming the variable-resistance element Rs is described below in detail with reference to FIGS. 5 through 7. All the elements of the temperature-measurement apparatus 400 except the variable-resistance element Rs are disposed on a circuit board 300 of the LCD 100. Specifically, the first through third fixed-resistance elements Rc1 through Rc3 and the differential amplifier 350 are disposed on the circuit board 300.

Referring to FIG. 2, the temperature-measurement apparatus 400 may also include buffers 340 and 341. The buffer 340 provides the differential amplifier 350 with the first temperature-dependent variable voltage Vtemp1 as it is. The buffer 341 provides the differential amplifier 350 with the reference voltage as it is. The buffers 340 and 341 may be operational amplifiers (OP).

In short, the temperature-measurement apparatus 400 outputs the first temperature-dependent variable voltage Vtemp1 that varies according to the temperature of the liquid crystal panel 200, and also outputs, with the aid of the differential amplifier 350, a noiseless second temperature-dependent variable voltage Vtemp2 with improved sensitivity.

The display area DA and the variable-resistance element Rs illustrated in FIG. 1 are described hereinafter in further detail with reference to FIGS. 5 through 7.

As shown in FIGS. 5-7, a plurality of gate lines 22, a temperature-sensing line 310, and a storage electrode line 28 are formed on an insulation substrate 10 which may be formed of transparent glass or plastic.

The gate lines 22 transmit a gate signal and extend substantially in a row direction. Each of the gate lines 22 includes a gate electrode 26 and a gate terminal 24 which has a large area for connecting a corresponding gate line 22 to a layer or an external driving circuit. A gate driving circuit (not shown) which generates a gate signal may be mounted on a flexible printed circuit film (not shown) which is attached onto the insulation substrate 10, or may be directly mounted on or integrated into the insulation substrate 10. If the gate driving circuit is directly integrated into the insulation substrate 10, the gate lines 22 may be directly connected to the gate driving circuit.

The temperature-sensing line 310 extends in the row direction, however the direction is not important or critical. By elongating the temperature-sensing line 310 in this manner, the resistance of the temperature-sensing line 310 can be increased, and, thus, the sensitivity of the temperature-sensing line 310 can also be increased. The temperature-sensing line 310 has end portions 321 and 324 which are wider than the rest of the temperature-sensing line 310 and can thus be used to receive/output a driving signal and to connect the temperature-sensing line 310 to an external driving circuit. Specifically, the end portion 321 may be an input terminal to which signals are applied, and, thus, the first input voltage Vin1 of FIG. 1 may be applied thereto. The end portion 324 may be an output terminal that outputs signals, may be connected to the first fixed-resistance element Rc1 of FIG. 1, and may output the first temperature-dependent variable voltage Vtemp1. The temperature-sensing line 310 and the end portions 321 and 324 may constitute the fixed resistor Rs of FIG. 1.

The storage electrode line 28 to which a predetermined voltage is applied extends substantially in parallel with the gate lines 22. The storage electrode line 28 includes a storage electrode 27 which is wider than the rest of the storage electrode line 28. The storage electrode 27 is disposed between a pair of adjacent gate lines 22 and overlaps a pixel electrode 82. The shape and the arrangement of the storage electrode line 28 are not restricted to those illustrated in FIG. 5, and may be altered in various manners.

Each of the gate lines 22, the temperature-sensing line 310, and the storage electrode line 28 may comprise a single-layered or multi-layered film that is formed of aluminum (Al), copper (Cu), platinum (Pt), or chromium (Cr). If each of the gate lines 22, the temperature-sensing line 310, and the storage electrode line 28 is comprised of a multi-layered film that consists of a lower film and an upper film, the lower film may be formed of a low-resistivity metal such as an aluminum-based metal (e.g., aluminum (Al) or an aluminum alloy), a silver-based metal (e.g., silver (Ag) or a silver alloy), or a copper-based metal (e.g., copper (Cu) or a copper alloy), and the upper film may be formed of a molybdenum-based metal (e.g., molybdenum (Mo) or a molybdenum alloy), a nitride of a molybdenum-based metal, chromium (Cr), tantalum (Ta), or titanium (Ti).

The gate lines 22, the temperature-sensing line 310, and the storage electrode line 28 may be formed using a sputtering method.

A gate insulation layer 30 is disposed on the gate lines 22. The temperature-sensing line 310, and the storage electrode line 28 are formed of silicon nitride (SiNx) or silicon oxide (SiOx).

A semiconductor layer 40 is disposed on the gate insulation layer 30 and is formed of hydrogenated amorphous silicon or polysilicon. The semiconductor layer 40 is formed as an island and overlaps each of the gate electrodes 26 of the gate lines 22.

Ohmic contacts 55 and 56 are disposed on the semiconductor layer 40. The ohmic contacts 55 and 56 may be formed of n+ hydrogenated amorphous silicon doped with a high concentration of n-type impurities (such as phosphor), or may be formed of silicide.

A plurality of data lines 62 and a plurality of drain electrodes 66 are disposed on the ohmic contacts 55 and 56 and the gate insulation layer 70. The data lines 62 transmit a data signal, extend substantially in a column direction, and intersect the gate lines 22. Each of the data lines 62 has a source electrode 65 and an end portion 68 which is wider than the rest of a corresponding data line 62 and can thus be used to connect the source electrode 65 to a layer or an external driving circuit. A data-driving circuit (not shown) which generates a data signal may be mounted on a flexible printed circuit film (not shown), which is attached onto the insulation substrate 10, or may be directly mounted on or integrated into the insulation substrate 10. If the data-driving circuit is directly integrated into the insulation substrate 10, the data lines 22 may be directly connected to the gate driving circuit. A drain electrode 66 includes a drain electrode extension 67, and is separated from the data line 62. The source electrode 65 and the drain electrode 66 are disposed on opposite sides of a gate electrode 26.

A gate electrode 26, a source electrode 65, and a drain electrode 66 constitute a thin film transistor (TFT) along with the semiconductor layer 40.

A passivation layer 70 is disposed on the data lines 62 and the drain electrode 66.

The passivation layer 70 may be formed of an inorganic dielectric material or an organic dielectric material, and may have a planarized surface. Examples of the inorganic dielectric material include silicon nitride and silicon oxide.

A plurality of contact holes 78 and 77 are formed through the passivation layer 70 so that the end portion 68 and the drain electrode extension 67 can be respectively exposed through the contact holes 78 and 77. Specifically, the contact hole 74 is formed through the passivation layer 70 and the gate insulation layer 30 so that the gate terminal 24 can be exposed through the contact hole 74. In addition, contact holes 322 and 325 are also formed through the passivation layer 70 and the gate insulation layer 30 so that the end portions 321 and 324 of the temperature-sensing line 310 can be respectively exposed through the contact holes 322 and 325.

A pixel electrode 82 and a plurality of contact assistants 84, 88, 323, and 326 are disposed on the passivation layer 70. The pixel electrode 82 and the contact assistants 84, 88, 323, and 326 may be formed of a transparent conductive material such as ITO or IZO or a reflective metal such as aluminum, silver, chromium, or an alloy thereof.

The pixel electrode 82 is physically and electrically connected to the drain electrode extension 67 via the contact hole 77, and, thus, a data voltage can be applied to the pixel electrode 82 by the drain electrode 66. When a data voltage is applied to the pixel electrode 82, the pixel electrode 82 generates an electric field along with a common electrode (not shown) which is disposed on a display panel (not shown), other than a current display panel including the pixel electrode 82, and to which a common voltage is applied. The orientation of liquid crystal molecules in a liquid crystal layer (not shown) interposed between the pixel electrode 82 and the common electrode is determined by the electric field. The polarization of light that is transmitted through the liquid crystal layer may vary according to the orientation of liquid crystal molecules in the liquid crystal layer. The pixel electrode 82 overlaps the storage electrode 27 and the storage electrode line 28, and can thus maintain a voltage by which the liquid crystal layer is charged.

The temperature-sensing line 310 may be disposed on a level with the gate lines 22, and the area of the temperature-sensing line 310 may be less than about 2 mm×2 mm. However, the shape, orientation, and size of the temperature-sensing line 310 and how to form the temperature-sensing line 310 are not restricted to those set forth herein.

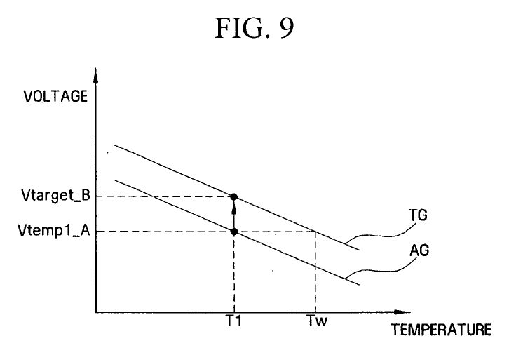

An LCD according to another embodiment of the present invention will hereinafter be described in detail with reference to FIGS. 8 and 9. FIG. 8 is a block diagram of an LCD 101 according to an embodiment of the present invention, and FIG. 9 is a graph for explaining an operation of a calibrator 500 illustrated in FIG. 8. In FIGS. 1, 2 and 8, like reference numerals refer to like elements, and, thus, detailed descriptions thereof will be skipped.

Referring to FIG. 8, the LCD 101 includes a temperature sensor 330, a memory 600, and the calibrator 500. The calibrator 500 calibrates a first temperature-dependent variable voltage Vtemp1 output by the temperature sensor 330, and outputs temperature information INFO. The calibrator 500 and the memory 600 may be mounted on the circuit board 300 of FIG. 1.

Referring to FIG. 9, a target temperature-voltage graph TG represents a target voltage corresponding to any given temperature, and an actual temperature-voltage graph AG represents a first temperature-dependent variable voltage Vtemp1 that is output at any given temperature by the temperature sensor 330. The calibrator 500 calibrates a first temperature-dependent variable voltage Vtemp1_A, which is output at a first temperature T1 by the temperature sensor 330, so that the first temperature-dependent variable voltage Vtemp1_A can become as high as a target voltage Vtarget_B. Thereafter, the calibrator 500 outputs temperature information INFO regarding the target voltage Vtarget_B.

As described above, a variable-resistance element Rs of the temperature sensor 330 may be a thin metal film disposed on a liquid crystal panel. The thickness of the temperature-sensing line 310 of FIG. 5 may be varied due to process drift, and, thus, the resistance of the variable-resistance element Rs may be arbitrarily determined according to temperature. In this case, the first temperature-dependent variable voltage Vtemp1 may become less reliable. That is, assuming that the temperature sensor 330 including the variable-resistance element Rs actually outputs the first temperature-dependent variable voltage Vtemp1_A at the first temperature T1, and assuming that the temperature sensor 330 is supposed to output the target voltage Vtarget_B at the first temperature T1 under ideal conditions with no process drift; process drift may result in a discrepancy between the first temperature-dependent variable temperature Vtemp1 and a first target voltage Vtarget1.

The first temperature-dependent variable voltage Vtemp1_A does not precisely reflect the temperature of a liquid crystal panel. For example, a functional block that processes an image signal with reference to the temperature of a liquid crystal panel is required to precisely learn the temperature of the liquid crystal panel. However, if the temperature sensor 330 outputs the first temperature-dependent variable voltage Vtemp1_A, instead of the target voltage Vtarget_B, at the first temperature T1 due to process drift, the function block may mistakenly determine that the liquid crystal panel has a temperature Tw, rather than the first temperature T1. Therefore, the calibrator 500 is necessary for calibrating the first temperature-dependent variable voltage Vtemp1_A to become as high as the first target voltage Vtarget1. That is, the calibrator 500 is provided with the first temperature-dependent variable voltage Vtemp1_A corresponding to the first temperature T1, calibrates the first temperature-dependent variable voltage Vtemp1_A to become as high as the target voltage Vtarget_B, and outputs temperature information INFO regarding the target voltage Vtarget_B. The calibrator 500 may calibrate the first temperature-dependent variable voltage Vtemp1_A using calibration data provided by the memory 600.

Specifically, assuming that digital data regarding the first temperature-dependent variable voltage Vtemp1_A is referred to as temperature-dependent variable data, the calibrator 500 may be provided with the first temperature-dependent variable voltage Vtemp1_A, may convert the first temperature-dependent variable voltage Vtemp1_A into the temperature-dependent variable data, may perform a logic operation on the temperature-dependent variable data using calibration data Dcal, which is previously stored in the memory 600, and may output temperature information INFO as the result of the logic operation. The temperature information INFO may be digital or analog information. That is, if the temperature-dependent variable data is binary data regarding the first temperature-dependent variable voltage Vtemp1_A and the calibration data Dcal is binary data regarding the difference between the first temperature-dependent variable voltage Vtemp1_A and the target voltage Vtarget_B, the calibrator 500 may add the temperature-dependent variable data and the calibration data Dcal, and output the result of the addition as the temperature information INFO. Alternatively, the calibrator 500 may add the temperature-dependent variable data and the calibration data Dcal, convert the result of the addition into an analog voltage, and output the analog voltage. In this case, the analog voltage may be the target voltage Vtarget_B.

The calibration data Dcal is described in further detail in the following. Referring to the target temperature-voltage graph TG and the actual temperature-voltage graph AG of FIG. 9, the calibration data Dcal is data regarding the difference between the target voltage Vtarget_B and the first temperature-dependent variable voltage Vtemp1_A. In order to calculate the calibration data Dcal, the first temperature-dependent variable voltage Vtemp1_A, which is output at the first temperature T1 by the temperature sensor 330, is measured, and the difference between the first temperature-dependent variable voltage Vtemp1_A and the target voltage Vtarget_B is calculated, where the difference between the first temperature-dependent variable voltage Vtemp1_A and the target voltage Vtarget_B is the calibration data Dcal. In this manner, the calibration data Dcal is calculated. If the target temperature-voltage graph TG and the actual temperature-voltage graph AG are straight lines having the same slope, as illustrated in FIG. 9, a first temperature-dependent variable voltage Vtemp1 corresponding to any given temperature may be calibrated using the same calibration data Dcal.

The calibration data Dcal may be stored in the memory 600. When the temperature sensor 330 outputs the first temperature-dependent variable voltage Vtemp1, the calibrator 500 reads the calibration data Dcal from the memory 600, and calibrates the first temperature-dependent variable voltage Vtemp1 using the calibration data Dcal.

If the LCD 101 includes a plurality of temperature sensors 300 which respectively provide a plurality of first temperature-dependent variable voltages Vtemp1, the calibrator 300 averages the plurality of first temperature-dependent variable voltages Vtemp1 and calculates calibration data Dcal regarding the average of the plurality of first temperature-dependent variable voltages Vtemp1 using the above-mentioned method. The calibration data regarding the average of the plurality of first temperature-dependent variable voltages Vtemp1 may be stored in the memory 600. When the temperature sensors 300 respectively outputs a plurality of first temperature-dependent variable voltages Vtemp1, the calibrator 500 reads the calibration data Dcal from the memory 600 and calibrate the average of the plurality of first temperature-dependent variable voltages Vtemp1 using the calibration data Dcal.

The LCD 101 can calibrate the resistance of the variable-resistance element Rs, and thus can precisely determine the temperature of a liquid crystal panel even when the reliability of the resistance of the variable-resistance element Rs becomes very low due to process drift.

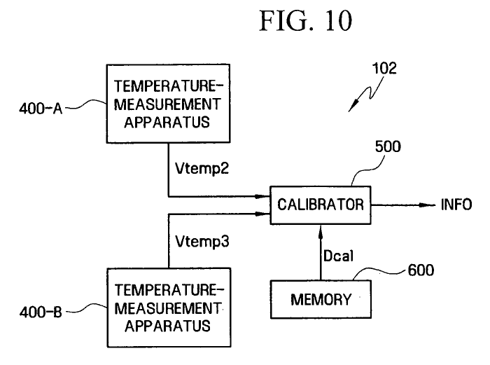

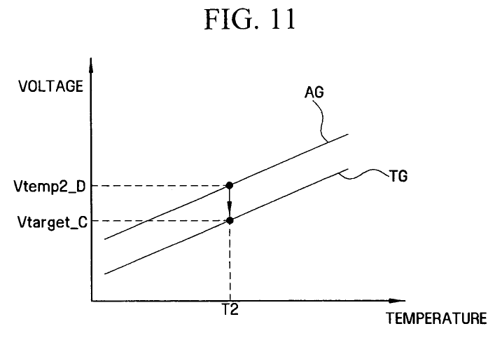

An LCD according to another embodiment of the present invention will hereinafter be described in detail with reference to FIGS. 10 and 11. FIG. 10 is a block diagram of an LCD 102 according to another embodiment of the present invention, and FIG. 11 is a graph for explaining an operation of a calibrator 500 illustrated in FIG. 10. In FIGS. 2, 8, and 10, like reference numerals refer to like elements, and, thus, detailed descriptions is unnecessary.

Referring to FIG. 10, the LCD 102, unlike the LCDs 100 and 101, receives a second temperature-dependent variable voltage Vtemp2 output by a temperature-measurement apparatus 400-A, calibrates the second temperature-dependent variable voltage Vtemp2, and outputs temperature information INFO. Alternatively, a second temperature-measurement apparatus 400-B can also be utilized. As illustrated in FIG. 10, temperature measurement apparatus 400-B outputs temperature-dependent voltage Vtemp3.

That is, a graph representing the second temperature-dependent variable voltage Vtemp2, i.e., the temperature-voltage graph AG, is the same as the graph of FIG. 4 representing the output of a differential amplifier.

Referring to FIG. 11, the calibrator 500 is provided with a second temperature-dependent variable voltage Vtemp2_D at a second temperature T2, calibrates the second temperature-dependent variable voltage Vtemp2 to be as low as a target voltage Vtarget_C, and outputs temperature information INFO regarding the target voltage Vtarget_C. For this, the calibrator 500 may read from the memory 600 calibration data Dcal regarding the difference between the second temperature-dependent variable voltage Vtemp2_D and the target voltage Vtarget_C, and use the calibration data to calibrate the second temperature-dependent variable voltage Vtemp2_D.

The LCD 102 can obtain a noiseless temperature-dependent variable voltage which has improved sensitivity and properly reflects the temperature of a liquid crystal panel. Also, the LCD 102 can calibrate the resistance of the variable-resistance element Rs, and can thus precisely determine the temperature of a liquid crystal panel even when the reliability of the resistance of the variable-resistance element Rs becomes very low due to process drift. As described above, LCD 102 may include a plurality of temperature-measurement apparatuses such as 400-A and 400-B. These apparatuses may be implemented like those described above. In this case, the calibrator 500 is provided with a plurality of second temperature-dependent variable voltages, calibrates the average of the plurality of second temperature-dependent variable voltages, and outputs temperature information INFO.

As described above, according to the present invention, it is possible to obtain a noiseless temperature-dependent variable voltage that has an improved sensitivity and that properly reflects the temperature of a liquid crystal panel. In addition, it is possible to calibrate the resistance of a variable-resistance element, and thus to precisely determine the temperature of a liquid crystal panel even when the reliability of the resistance of the variable-resistance element Rs becomes very low due to process drift.

While the present invention has been particularly shown and described with reference to exemplary embodiments thereof, it will be understood by those of ordinary skill in the art that various changes may be made in the form and details without departing from the spirit and scope of the present invention as defined by the following claims.

What is claimed is:

1. A liquid crystal display (LCD) comprising:
a liquid crystal panel; and
a temperature-measurement apparatus which comprises:
a temperature sensor comprising a variable-resistance element associated with the liquid crystal panel, the variable-resistance element exhibiting a resistance that varies as a function of a temperature of the liquid crystal panel, and a fixed-resistance element connected in series with the variable-resistance element, the series connected variable-resistance element and the fixed-resistance element being coupled to a first input voltage and providing at a first output a first temperature-dependent variable voltage that is a function of a temperature of the liquid crystal panel;
a voltage divider circuit coupled to a second input voltage, the voltage divider circuit providing at a second output a reference voltage; and
a differential amplifier having first and second inputs coupled respectively to the first and second outputs, the differential amplifier providing at an output a second temperature-dependent variable voltage which is a function of voltages received at the first and second inputs.

2. The LCD of claim 1, wherein a resistance of the variable-resistance element increases as a temperature of the liquid crystal panel increases, and decreases as a temperature of the liquid crystal panel decreases.

3. The LCD of claim 1, wherein the temperature sensor further comprises a buffer coupled to receive at an input the first temperature-dependent variable voltage and provide to the differential amplifier from an output the first temperature-dependent variable voltage unchanged.

4. The LCD of claim 1, wherein the liquid crystal panel is divided into a display area and a non-display area, and the variable-resistance element is formed in the non-display area.

5. The LCD of claim 1, wherein the differential amplifier increases a range of variation of the first temperature-dependent variable voltage according to the temperature of the liquid crystal panel and outputs the second temperature-dependent variable voltage.

6. The LCD of claim 1, further comprising a calibrator which calibrates the second temperature-dependent variable voltage and outputs temperature information,
wherein the calibrator calibrates the second temperature-dependent variable voltage to a target voltage on a target temperature-voltage graph, and outputs temperature information regarding the target voltage on the target temperature-voltage graph, the target temperature-voltage graph indicating a target voltage corresponding to the temperature of the liquid crystal panel.

7. The LCD of claim 6, further comprising a memory coupled to the calibrator, the memory being adapted to store calibration data for calibrating the second temperature-dependent variable voltage to the target voltage on the target temperature-voltage graph, and provides the calibrator with the calibration data.

8. The LCD of claim 1, wherein the variable-resistance element comprises a conductive material.

9. An LCD comprising:
a liquid crystal panel;
one or more temperature-measurement apparatuses associated with the liquid crystal panel, the one or more temperature-measurement apparatuses being operative to output one or more temperature-dependent voltages having a magnitude which is a function of a temperature of the liquid crystal panel; and
a calibration circuit operative to calibrate the one or more temperature dependent voltages and output temperature information,
wherein the calibration circuit is operative to calibrate the first temperature-dependent variable voltage to be a target voltage on a target temperature-voltage graph, and outputs temperature information regarding the target voltage on the target temperature-voltage graph, the target temperature-voltage graph indicating a target voltage corresponding to the temperature of the liquid crystal panel.

10. The LCD of claim 9, wherein the calibrator converts the first temperature-dependent variable voltage into digital temperature-dependent variable data, performs a logic operation on the digital temperature-dependent variable data using previously stored calibration data, and outputs the temperature information.

11. The LCD of claim 10, further comprising a memory coupled to the calibrator, the memory being adapted to store and provide the calibrator with the calibration data.

12. The LCD of claim 10, wherein the calibrator calculates an average of a plurality of first temperature-dependent variable voltages output by the temperature-measurement apparatuses, calibrates the average of the plurality of first temperature-dependent variable voltages, and outputs the temperature information.

13. The LCD of claim 9, wherein each of the temperature-measurement apparatuses comprise a variable-resistance element having a resistance that varies according to the temperature of the liquid crystal panel and a fixed-resistance element connected in series to the variable-resistance element, divides an input voltage and outputs the first temperature-dependent variable voltage.

14. The LCD of claim 9, wherein each of the temperature-measurement apparatuses comprises:
a temperature sensor comprising a variable-resistance element having a resistance that varies according to the temperature of the liquid crystal panel and a fixed-resistance element connected in series to the variable-resistance element, divides a first input voltage, and outputs a second temperature-dependent variable voltage that varies according to a temperature of the liquid crystal panel;
a voltage divider dividing a second input voltage, and outputting a reference voltage; and
a differential amplifier amplifying a difference between the second temperature-dependent variable voltage and the reference voltage, and outputting the first temperature-dependent variable voltage.

15. The LCD of claim 14, wherein each of the temperature-measurement apparatuses further comprises a buffer which provides the differential amplifier with the unchanged second temperature-dependent variable voltage.

16. The LCD of claim 13, wherein the variable-resistance element comprises a conductive material, and the resistance of the variable-resistance element increases as the temperature of the liquid crystal panel increases, and decreases as the temperature of the liquid crystal panel decreases.

17. The LCD of claim 13, wherein the liquid crystal panel is divided into a display area and a non-display area, and the variable-resistance element is formed in the non-display area.

18. The LCD of claim 14, wherein the variable-resistance element comprises a conductive material, and the resistance of the variable-resistance element increases as the temperature of the liquid crystal panel increases, and decreases as the temperature of the liquid crystal panel decreases.

19. The LCD of claim 14, wherein the liquid crystal panel is divided into a display area and a non-display area, and the variable-resistance element is formed in the non-display area.
